(19) United States
(12) Patent Application Publication
(10) Pub. No.: US 2013/0005847 A1
(43) Pub. Date: Jan. 3, 2013

(54) POLYURETHANE FOAM CONTAINING SILICONE

(75) Inventor: Jens Cremer, Munich (DE)

(73) Assignee: WACKER CHEMIE AG, Munich (DE)

(21) Appl. No.: 13/635,547

(22) PCT Filed: Mar. 4, 2011
(86) PCT No.: PCT/EP2011/053253

§ 371 Date: Sep. 17, 2012

(30) Foreign Application Priority Data
Mar. 15, 2010 (DE) 10 2010 002 880.0

(51) Int. Cl. C08L 83/04; C08J 9/14; C08L 75/12

(52) U.S. Cl. 521/154; 264/54

(57) ABSTRACT

Silicone-containing polyurethane foams of low density, good pore structure, and high surface quality are prepared by reacting a branched, preferably hyperbranched silicone polyol with a polyisocyanate and a silicone resin in the presence of a reactive or non-reactive blowing agent.

### CROSS-REFERENCE TO RELATED APPLICATIONS

This application is the U.S. national phase of PCT Appln. No. PCT/EP2011/053253 filed Mar. 4, 2011, which claims priority to German Patent Application No. 10 2010 002 880.0 filed Mar. 15, 2010, which are incorporated herein by reference.

### BACKGROUND OF THE INVENTION

1. Field of the Invention

This invention relates to foamable preparations based on organosilicon compounds, to silicone-containing polyurethane foams having low densities, in particular molded foams, and also to processes for the production thereof.

2. Description of the Related Art

Polyurethane foams are generally prepared by reaction of a polyisocyanate with compounds containing two or more active hydrogen atoms. The compounds containing active hydrogen are typically polyols, primary and secondary polyamines, and water. Between these reactants there are two principal reactions that occur during the preparation of a polyurethane foam. These reactions must in principle run simultaneously and with a competitively balanced rate during the operation, in order to produce a polyurethane foam having desired physical properties. The reaction between the isocyanate and the polyol or polyamine, which is typically termed a gel reaction, leads to the formation of a polymer with a high molecular weight. The progress of this reaction increases the viscosity of the mixture and contributes generally to the formation of crosslinking with polyfunctional polyols. The second principal reaction takes place between the polyisocyanate and water. This reaction contributes to the growth of the urethane polymer and is important for the formation of carbon dioxide gas, which assists the foaming process. Consequently this reaction is often termed the blowing reaction. Both the gel reaction and the blowing reaction take place in foams which are blown partially or completely with carbon dioxide gas. If, for example, the evolution of carbon dioxide is too rapid by comparison with the gel reaction, the foam exhibits a proclivity to collapse. If, alternatively, the gel expansion reaction is too rapid as compared with the blowing reaction that produces carbon dioxide, foam rise is limited, and a high-density foam is produced. Similarly, poorly matched crosslinking reactions will impact adversely on foam stability.

The polyols used are generally polypropylene glycols, which in accordance with the prior art can be prepared in a very wide variety of topologies, and differ from one another in molecular weight, degree of branching, and OH number. In spite of the broad structural variation of these polyols and the associated tailoring of the polyurethane foams to virtually any application, the inherent flammability of the commercially available polyurethane foams is a serious drawback. In spite of great efforts, success has so far not been achieved in establishing absolutely inflammable flexible PU foams on the market, although in recent decades there has been no lack of intense research activities aimed at improving the flame retardancy properties of polymer foams.

One route to flame-retarded, flexible PU foams is taken in silicone-polyurethane flexible foams. In such foams, the highly combustible polyol component that is used in standard PU foams is replaced by incombustible, OH-terminated siloxanes. Through the use of silicone-polyurethane copolymers, i.e., of polysiloxanes, which also contain polyurethane units and/or urea units, it is possible to develop incombustible foam materials of this kind which have new combinations of properties that are tailored precisely to the particular application. Reference on this point may be made, for example, to EP 1485419 B1, which describes the preparation of silicone-polyurethane foams starting from alkylamino- or alkylhydroxy-terminated silicone oils and diisocyanates in what is called a “one-shot” process. Furthermore, DE 102006013416 A1 describes the preparation of silicone-PU foams from prepolymers which are prepared in a solvent-based operation on the basis of alkylamino- or alkylhydroxy-terminated silicone oils and diisocyanates.

A feature which unites the silicone-polyurethane foams that have been described to date is that they are prepared on the basis of siloxanes which are linear or have only very slight, but statistical, branching in the side chains. In view of this linear siloxane chain, the rise phase during foaming is not accompanied by an increase in molar mass, and so the increase in viscosity during the rise phase is relatively slow, meaning that the polymer matrix, even after the end of the blowing reaction, is generally slightly fluid, and, therefore, the fine cell structure may still collapse before curing of the foam is complete. Even if only a small fraction of the cell structure collapses in on itself, the result is a coarse and irregular cell distribution. In order to counteract cell collapse when using linear polyol components, the struts connecting the individual foam cells must not fall below a critical diameter during the rise phase. Hence it is ensured that the still fluid polymatrix is able to counteract the threat of collapse of the foam structure. If, however, the desired foam density selected is too low, then the cell struts become increasingly thin during the rise phase until, finally, they become too flexible to stabilize the cell structure. Accordingly, in general, linear siloxanes result only in silicone-PU foams having densities of distinctly above 100 kg/m³.

Hyperbranched polymers are already known and are discussed exhaustively, for example, in the review article by C. Gao, D. Yan; Prog. Polym. Sci., 2004, 24, 183-275, in relation to synthesis, properties, and applications. Hyperbranched polymers are a subset of dendritic macromolecules, and possess greater branching than conventionally branched polymers, which primarily have primary or secondary branches on a linear main chain. To date, for the synthesis of hyperbranched polymers, divergent synthesis methods have been employed, where a monomer possesses just two different kinds of functional groups that react with one another, but not with themselves, the functionality of the monomers being in total greater than two. Examples of suitable monomers are those which possess one functional group A and two functional groups B, i.e., an AB₂ monomer. In principle it is possible to use all monomers ABₓ where x>1. The use of ABₓ monomers in a monomolecular polymerization, however, is possible only when the A and B groups react with one another only when such reaction is desired in the polymer synthesis, in other words following addition of a catalyst or as a result of an increase in temperature. An alternative possibility is for hyperbranched polymers to be synthesized with two different types of monomer each having only one kind of functional groups, but in different numbers, such as A₃ and B₂ units, for example. Through a reaction of these two A₃ and B₂ types it is then possible in situ to obtain A₂B and AB₂ monomer blocks (di-molecular polymerization: generally with Aₓ and B_{y}, where x>1 and y>2). Processes of this kind are general knowledge and are described, for example, in U.S. Pat. No. 6,534,600.

A further disadvantage with the silicone-PU foams described to date is that NCO-terminated silicone prepolymers have to be used if silicone-PU foams having low densities are to be obtained. The preparation of appropriate prepolymers requires an additional step of synthesis and, moreover, such prepolymers have but limited stability in storage at elevated temperatures in particular.

It would accordingly be desirable to have a process whereby the classic one-shot method can be utilized in foam production. In such a process, the polyol and isocyanate parts would be prepared independently of each other and would only be made to react with each other in the foaming operation.

The known NCO-terminated silicone prepolymers further cannot be used to produce molded foams having optimal properties, since the molded foams obtained therewith have very coarse and irregular cells directly under the skin, creating the haptic impression of inferior quality. It is accordingly desirable to be able to produce silicone-PU foams to the same quality as conventional molded polyurethane foams. For this they need to have a completely uninterrupted and homogeneous surface which transitions directly into the fine-cell structure in their interior.

### SUMMARY OF THE INVENTION

It has now been surprisingly and unexpectedly discovered that silicone-containing polyurethane foams of low density, uniform cell structure, and high surface quality may be prepared by reacting a silicone-containing hyperbranched polyol, a polyisocyanate, and a silicone resin.

### DETAILED DESCRIPTION OF THE PREFERRED EMBODIMENTS

The present invention thus provides foamable compositions containing siloxanes (A) of the formula

V—(NHC(O)R¹R²)ₚ₋ₘ₋ₙ(NHC(O)R¹R⁴[SiR₂O]ₐ—SiR₂R⁴R¹H)ₘ(NHC(O)NR⁵₂)ₙ (I)

where
V is a p-valent hydrocarbon radical which may contain heteroatoms,
R in each occurrence can be the same or different and is a monovalent, optionally substituted hydrocarbon radical,
R¹ in each occurrence can be the same or different and is —O—, —S— or —NR³—,
R² in each occurrence can be the same or different and represents a hydrogen atom or a monovalent, optionally substituted hydrocarbon radical,
R³ is hydrogen or a monovalent, optionally substituted hydrocarbon radical,
R⁴ in each occurrence can be the same or different and is a divalent, optionally substituted hydrocarbon radical which can be interrupted by heteroatoms,
R⁵ in each occurrence can be the same or different and is hydrogen or an optionally substituted hydrocarbon radical,
a is an integer not less than 1, preferably in the range from 1 to 1000, more preferably in the range from 5 to 500 and most preferably in the range from 10 to 100,
p is an integer not less than 2, preferably in the range from 2 to 20 and more preferably 3 or 4,
m is an integer not less than 1, preferably in the range from 1 to 19 and more preferably in the range from 1 to 3,
n is an integer not less than 1, preferably in the range from 1 to 19 and more preferably in the range from 1 to 3,
with the proviso that p is not less than m+n, polyisocyanates (B) and organopolysiloxane resins (C).

Examples of R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical; alkenyl radicals such as the vinyl and the allyl radical; cycloalkyl radicals such as the cyclopentyl, cyclohexyl, cycloheptyl and methylcyclohexyl radicals; aryl radicals such as the phenyl and the naphthyl radicals; alkaryl radicals such as the o-, m-, p-tolyl radicals, xylyl radicals, and ethylphenyl radicals; aralkyl radicals such as the benzyl radical and the α- and the β-phenylethyl radicals.

Examples of substituted hydrocarbon radicals R are alkoxyalkylene radicals such as the methoxymethylene and ethoxymethylene radicals, hydroxyalkylene radicals such as the 2-hydroxyethylene radical, and aminoalkylene radicals such as the dimethylaminoethylene, diethylaminomethylene, 2-aminoethylene and N-methylaminoethylene radicals.

The radical R preferably comprises monovalent, optionally substituted hydrocarbon radicals having from 1 to 40 carbon atoms, more preferably hydrocarbon radicals having from 1 to 6 carbon atoms and in particular, the methyl radical.

Examples of R³ are hydrogen and the examples recited for the radical R. The R³ radical is preferably hydrogen.

R¹ preferably comprises —O—.

Examples of R² radicals are hydrogen and also the examples mentioned for the radical R. The R² radical preferably comprises hydrocarbon radicals having from 1 to 6 carbon atoms and more preferably comprises the methyl radical.

Examples of the R⁴ radical are methylene, ethylene, propylene, butylene, pentylene, hexamethylene, methyloxyethylene, i.e. the radical —CH₂—O—CH₂CH₂—, tolylene, methylenebisphenylene, phenylene, naphthylene, cyclohexylene and isophorone radicals. Preferably R⁴ comprises divalent, aliphatic hydrocarbon radicals which may be interrupted by heteroatoms, more preferably comprises propylene, methylene and methyloxyethylene radicals, yet more preferably comprises the methylene and methyloxyethylene radicals, and most preferably comprises methylene.

Examples of R⁵ are the radicals recited for R. R⁵ preferably comprises hydrogen and optionally hydroxyl-substituted hydrocarbon radicals, more preferably optionally hydroxyl-substituted hydrocarbon radicals, and most preferably comprises alkyl radicals having from 1 to 6 carbon atoms and hydroxyalkyl radicals having from 1 to 6 carbon atoms.

Examples of the radical V are any desired, previously known polyvalent, aliphatic or aromatic hydrocarbon radicals which may include heteroatoms, such as 1,3,4-benzene radicals, 1,3,5-cyanurate radicals, N,N,N′-biuret radicals, 4,4′,4″-triphenylmethane radicals and poly((4-phenyl)coformaldehyde) radicals.

The radical V preferably comprises polyvalent radicals having from 1 to 50 carbon atoms and more preferably having from 6 to 30 carbon atoms.

V preferably comprises polyvalent, aromatic, optionally heteroatom-containing hydrocarbon radicals, more preferably polyvalent aromatic, optionally nitrogen-, oxygen- and phosphorus-containing hydrocarbon radicals, and most preferably polyvalent aromatic, optionally nitrogen- and oxygen-containing hydrocarbon radicals having from 6 to 30 carbon atoms.

In the siloxanes (A) of formula (I) which are used according to the present invention, the sum total m+n is preferably equal to p.

The siloxanes (A) of formula (I) which are used according to the present invention preferably have a viscosity of 100 to 10,000 mPas and more preferably 500 to 5000 mPas, all measured at 25° C. according to ASTM D 4283.

The siloxanes (A) used according to the present invention are preferably hyperbranched.

Examples of siloxanes (A) used according to the present invention are

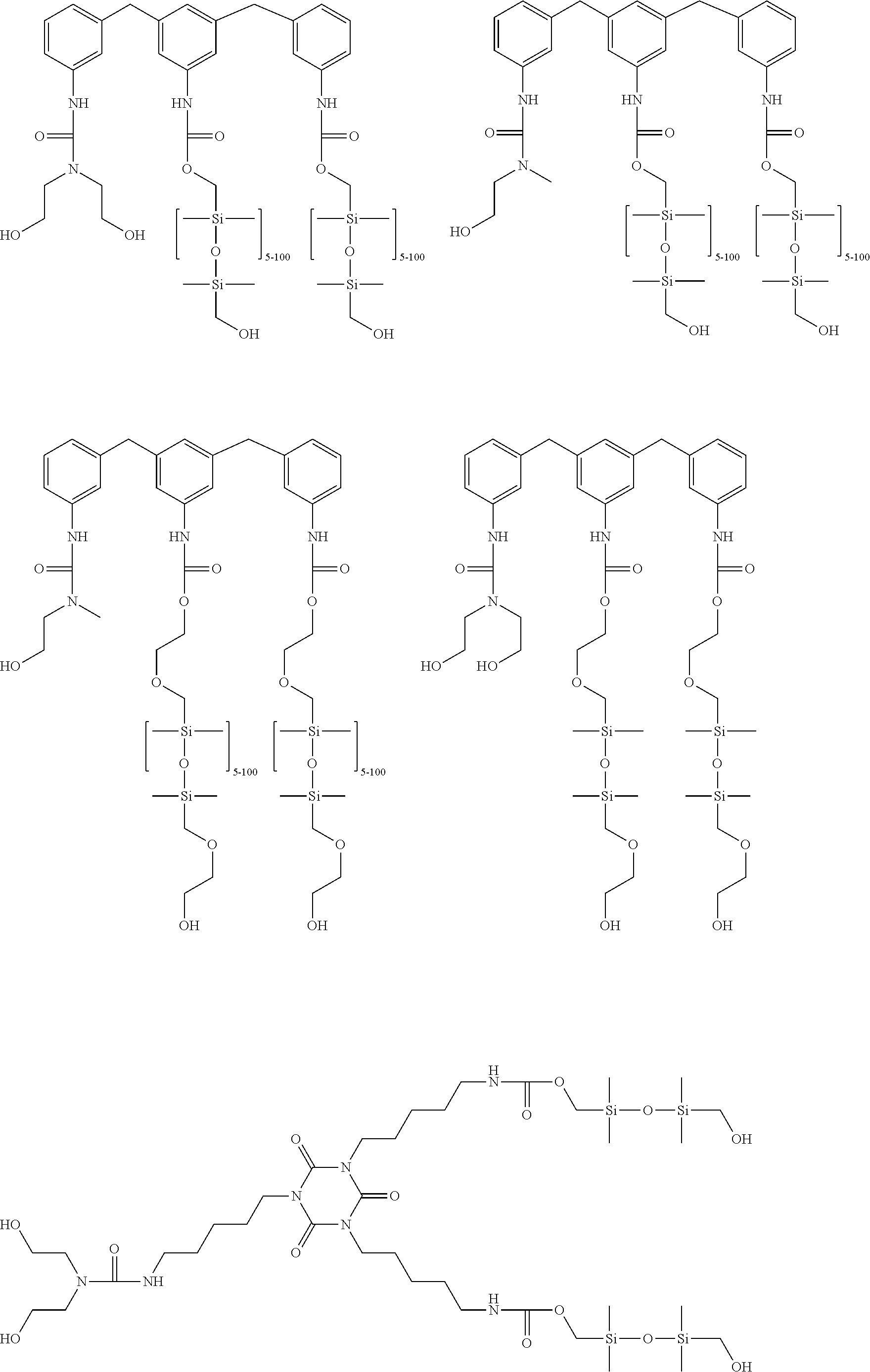

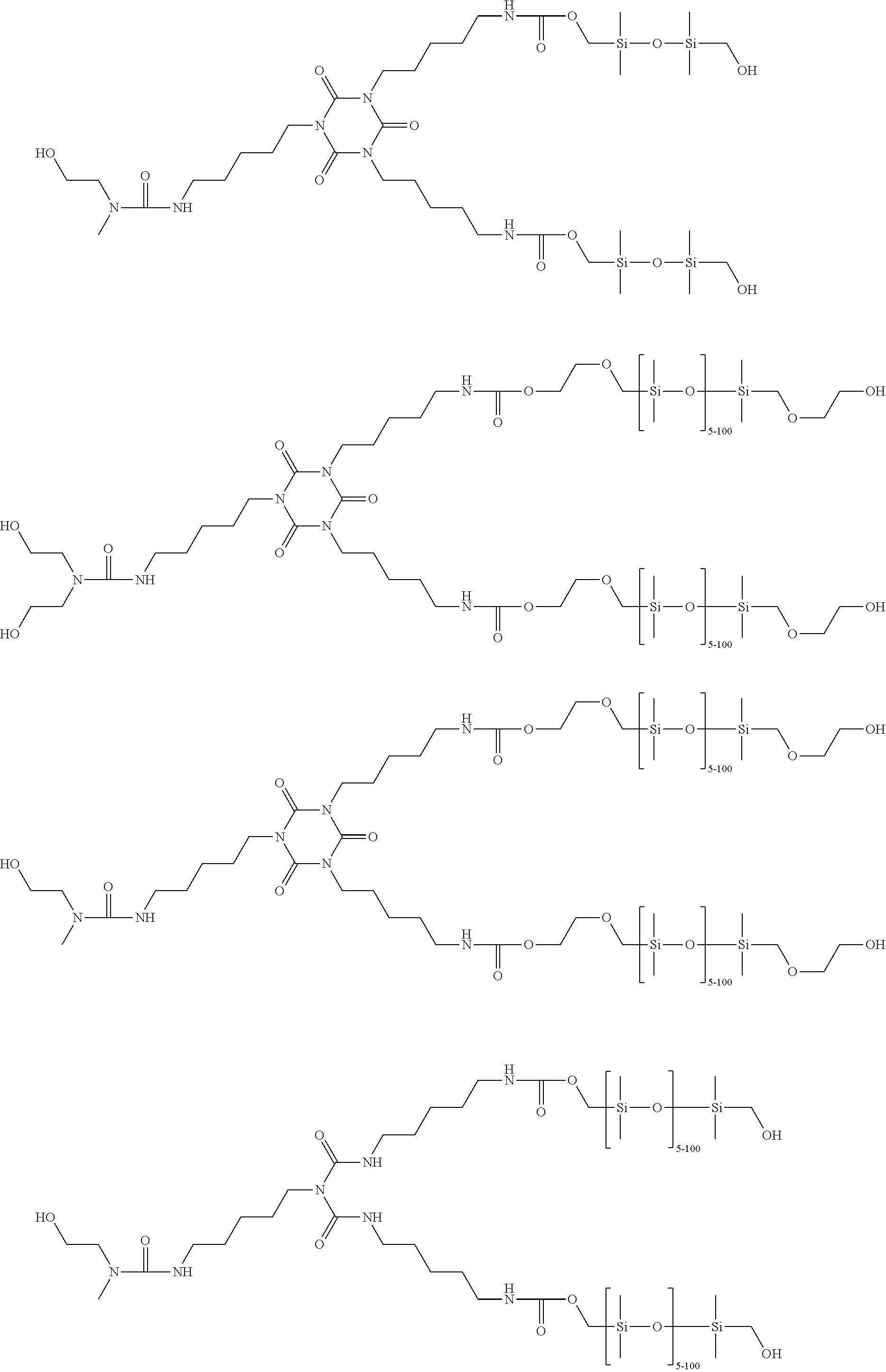

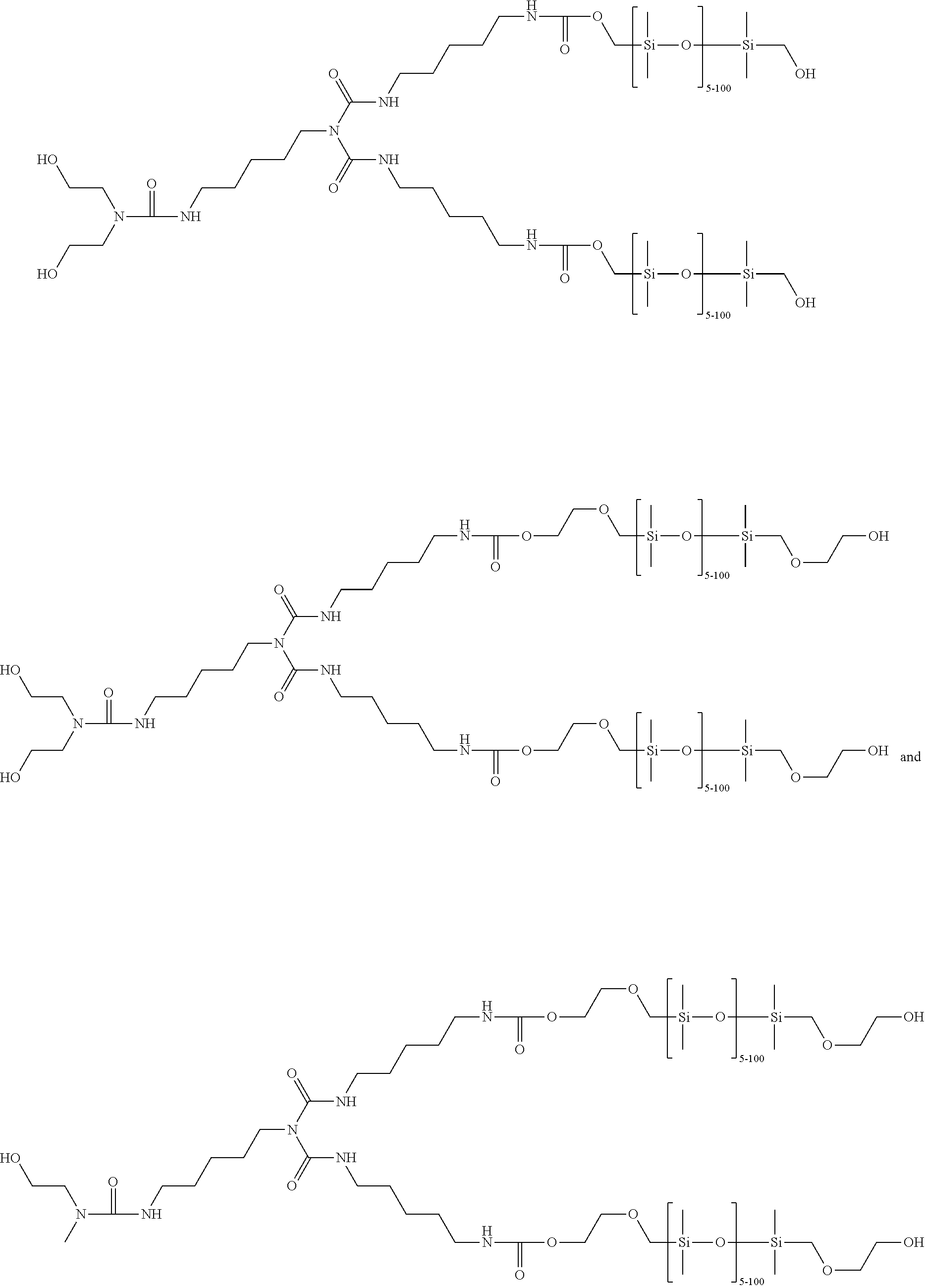

The siloxanes (A) used according to the present invention preferably are:

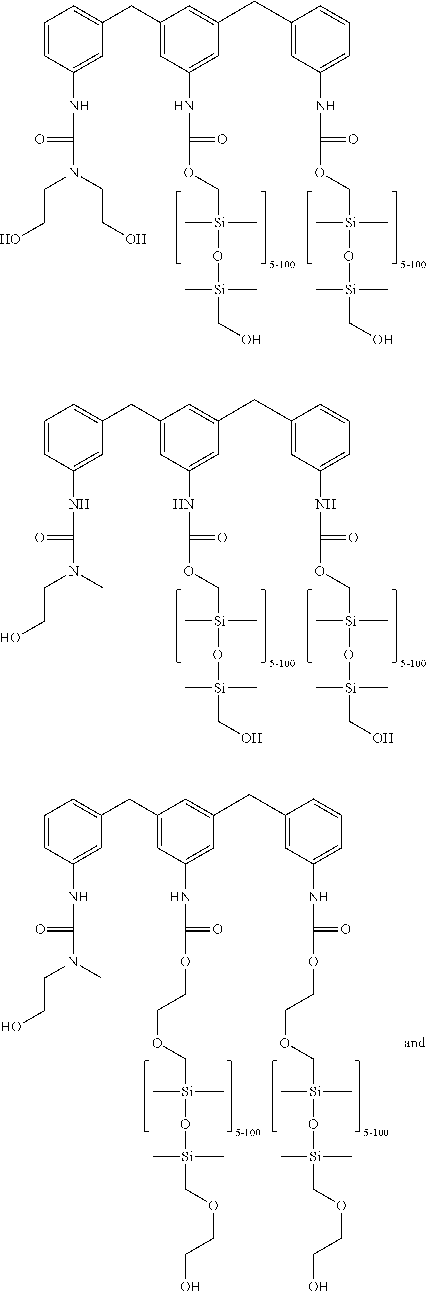

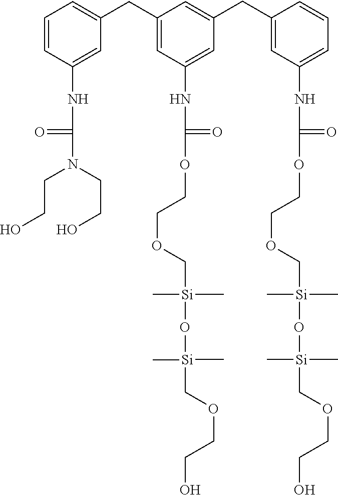 [SMILES: C[Si](C)(COCCO)O[Si](C)(C)COCCOC(=O)Nc1cccc(Cc2cc(Cc3cccc(NC(=O)N(CCO)CCO)c3)cc(NC(=O)OCCOC[Si](C)(C)O[Si](C)(C)COCCO)c2)c1]

The siloxanes (A) used according to the present invention more preferably are:

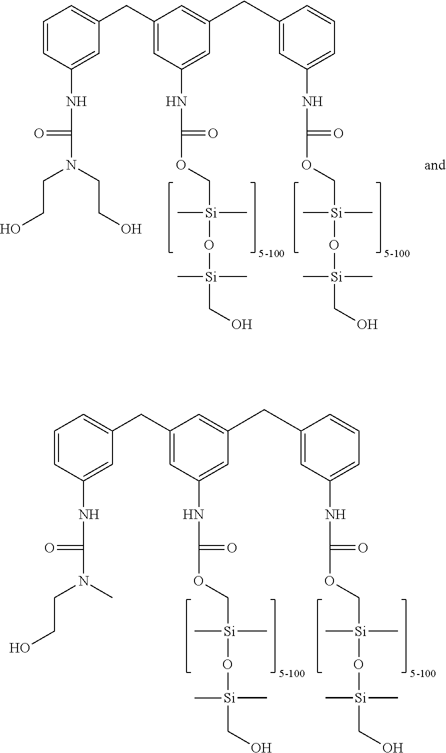

The siloxanes (A) used according to the present invention are obtainable by commonplace methods in silicon chemistry.

The siloxanes (A) used according to the present invention preferably comprise those obtainable by reaction of
(i) a linear α,ω-aminoorganyl-functionalized or α,ω-hydroxyorganyl-functionalized siloxane with
(ii) a polyisocyanate and
(iii) an amine.

Component (i) preferably comprises siloxanes of the formula

HR¹R⁴[SiR₂O]ₐ—SiR₂R⁴R¹H (II)

where R, R¹, R⁴ and a are each as defined above.

Examples of component (i) are
HOCH₂—[SiMe₂O]₂₋₁₀₀—SiMe₂CH₂OH,
HOCH₂—CH₂—OCH₂—[SiMe₂O]₂₋₁₀₀—SiMe₂CH₂O—CH₂—CH₂OH,
H₂NCH₂—[SiMe₂O]₂₋₁₀₀—SiMe₂CH₂NH₂,
H₂NCH₂—CH₂—CH₂—[SiMe₂O]₂₋₁₀₀—SiMe₂CH₂—CH₂—CH₂NH₂ and
H₃C—HNCH₂—CH₂—CH₂—[SiMe₂O]₂₋₁₀₀—SiMe₂CH₂—CH₂—CH₂NH—CH₃,
   where Me is methyl. The process for preparing the aforementioned linear siloxanes is such that up to 0.1% of all units include branching, as in MeSiO_{3/2} or SiO_{4/2} units for instance.

Component (i) preferably comprises
HOCH₂—[SiMe₂O]₂₋₁₀₀—SiMe₂CH₂OH and
HOCH₂—CH₂—OCH₂—[SiMe₂O]₂₋₁₀₀—SiMe₂CH₂O—CH₂—CH₂OH,
   where HOCH₂—[SiMe₂O]₂₋₁₀₀—SiMe₂CH₂OH is particularly preferred.

The siloxanes (i) comprise commercially available products and/or are obtainable by methods commonplace in silicon chemistry.

The polyisocyanates (ii) used according to the present invention comprise all known di- or polyisocyanates.

Preference for use as polyisocyanates (ii) is given to those of the general formula

V(NCO)ₚ (III)

where
V and p each have one of the abovementioned meanings.

Examples of polyisocyanates (ii) are diisocyanato-diphenylmethane (MDI), not only in the form of crude or technical MDI but also in the form of pure 4,4′ and/or 2,4′ isomers or compositions thereof, tolylene diisocyanate (TDI) in the form of its various regioisomers, diisocyanatonaphthalene (NDI), isophorone diisocyanate (IPDI), 1,3-bis(1-isocyanato-1-methyl-ethyl)benzene (TMXDI) or else hexamethylene diisocyanate (HDI), and also polymeric MDI (p-MDI), triphenylmethane triisocyanate or biuret trimers or isocyanurate trimers of the abovementioned isocyanates.

Polyisocyanates (ii) are preferably used in amounts of from 0.1 to 30 parts by weight, more preferably from 0.1 to 20 parts by weight and most preferably from 1 to 10 parts by weight, all based on 100 parts by weight of siloxane (i).

The amines (iii) used according to the present invention preferably comprise those of the formula

HNR⁵₂ (IV)

where R⁵ has one of the abovementioned meanings and preferably not more than one R⁵ radical is hydrogen, and also aliphatic cyclic amines and aromatic cyclic amines which may include additional functional groups such as thiol, hydroxyl or further amino groups.

Examples of amines (iii) are dimethylamine, diethyl-amine, butylamine, dibutylamine, diisopropylamine, pentylamine, cyclohexylamine, N-methylcyclohexylamine, aniline, morpholine, pyrrolidine, piperidine, imidazole, piperazine, ethylenediamine, N,N′-dimethyl-ethylenediamine, ethanolamine, N-methylethanolamine, diethanolamine, propanolamine, alaminol, and N-methyl(thioethanol)amine.

The amines (iii) preferably comprise aliphatic amines, more preferably pyrrolidine, diethanolamine, ethanolamine and N-methylethanolamine and more preferably diethanolamine, ethanolamine and N-methyl-ethanolamine.

According to the present invention, amines (iii) are used in amounts of preferably from 0.1 to 20 parts by weight, more preferably from 0.1 to 10 parts by weight and more particularly from 0.5 to 5 parts by weight, all based on 100 parts by weight of siloxane (i).

When the starting materials (i), (ii) and (iii) are subjected to the reaction, it is preferable to use organic solvent (iv) and catalysts (v).

Examples of organic solvents (iv) are ethers, more preferably aliphatic ethers such as dimethyl ether, diethyl ether, methyl t-butyl ether, diisopropyl ether, dioxane or tetrahydrofuran, esters, more preferably aliphatic esters such as ethyl acetate or butyl acetate, ketones, more preferably aliphatic ketones such as acetone or methyl ethyl ketone, sterically hindered alcohols, more preferably aliphatic alcohols such as t-butanol, amides such as DMF, aliphatic nitriles such as acetonitrile, aromatic hydrocarbons such as toluene or xylene, aliphatic hydrocarbons such as pentane, cyclopentane, hexane, cyclohexane, and heptane, and chlorinated hydrocarbons such as methylene chloride or chloroform.

The organic solvents (iv) preferably comprise aliphatic ethers, aliphatic ketones or aliphatic nitriles, of which aliphatic ketones are particularly preferred.

When organic solvents (iv) are used, the amounts preferably comprise from 1 to 1000 parts by weight, more preferably from 10 to 500 parts by weight and most preferably from 30 to 200 parts by weight, all based on 100 parts by weight of siloxane (i). The reaction of the present invention preferably does utilize solvents (iv).

Examples of catalysts (v) are tin compounds such as dibutyltin dilaurate, dioctyltin dilaurate, dibutyltin diacetate, dibutyltin dioctoate, dibutyltin bis(dodecylmercaptide), and tin(II) 2-ethylhexanoate, zinc compounds such as zinc(II) 2-ethylhexanoate, bismuth compounds such as bismuth(III) neodecanoate, zirconium compounds such as zirconium tetrakis(2,2,6,6-tetramethylheptane-3,5-dionate), and amines such as 1,4-diazabicyclo[2,2,2]octane and tetramethylguanidine.

The catalysts (v) preferably comprise tin, zirconium or bismuth compounds, of which bismuth compounds are most preferred.

When catalysts (v) are used, the amounts involved preferably range from 1 to 1000 weight ppm, more preferably from 10 to 500 weight ppm and most preferably from 50 to 150 weight ppm, all based on the total weight of the reaction mixture. The reaction of the present invention preferably does utilize catalysts (v).

The components used for reaction may each comprise one type of such a component and also a mixture of two or more types of a particular component.

The reaction preferably comprises a first stage of reacting siloxanes (i) with polyisocyanates (ii) in the presence or absence of solvent (iv) and in the presence or absence of catalyst (v) and a second stage of reacting the resulting reaction mixture with amines (iii).

The reaction is preferably carried out at temperatures of 20 to 100° C. and more preferably 30 to 80° C.

The reaction is preferably carried out at the pressure of the ambient atmosphere, i.e., 900 to 1100 hPa, but can also be carried out at higher pressures, for example at 1200 to 10,000 hPa.

The reaction is preferably carried out under an inert gas atmosphere, such as nitrogen and argon for example.

The reaction mixture obtained after the reaction has ended can be worked up in any desired previously known manner. Preferably, any organic solvent used is removed, which is more preferably done distillatively and, as far as the technical possibilities allow, completely. The reaction mixture preferably does not contain any starting materials after conclusion of the reaction. When the reaction mixture does contain as yet unreacted starting materials, these preferably remain therein.

Useful isocyanates (B) for the purposes of the present invention include all known di- or polyisocyanates, for example the isocyanates recited above under (ii).

Preference for use as polyisocyanates (B) is given to those of the general formula

Q(NCO)_{b} (V)

where
Q is a b-functional, optionally substituted hydrocarbon radical and
b is an integer of at least 2, preferably in the range from 2 to 10, more preferably 2 or 4 and most preferably 2 to 3.

Preferably, Q comprises optionally substituted hydrocarbon radicals having from 4 to 30 carbon atoms and more preferably hydrocarbon radicals having from 6 to 25 carbon atoms.

The preparations of the present invention preferably contain isocyanates (B) in amounts of from 0.1 to 150 parts by weight, more preferably from 1 to 100 parts by weight and more particularly from 10 to 50 parts by weight, all based on 100 parts by weight of siloxane (A).

The preparations of the present invention preferably contain organopolysiloxane resins (C) in amounts of from 0.1 to 15 parts by weight, more preferably from 0.2 to 10 parts by weight and most preferably from 0.5 to 5 parts by weight, all based on 100 parts by weight of siloxane (A).

The organopolysiloxane resins (C) used according to the present invention preferably comprise units of the formula

R⁶_{c}X_{d}SiO_{(4-c-d)/2} (VI)

where
R⁶ in each occurrence can be the same or different and is hydrogen or a monovalent, optionally substituted,
SiC-bonded hydrocarbon radical,
X in each occurrence can be the same or different and is halogen, a radical R⁷O— or a radical R⁷₂N—,
R⁷ in each occurrence can be the same or different and is hydrogen or a monovalent, optionally substituted hydrocarbon radical,
c is 0, 1, 2 or 3, and
d is 0, 1, 2 or 3,
with the proviso that the sum total c+d is ≦3 and in less than 50% of all units of formula (VI) in the organopolysiloxane resin the sum c+d is equal to 2.

Examples of R⁶ and R⁷ radicals are independently hydrogen and also the examples recited above for R. Preferably, radical R⁶ comprises optionally substituted, SiC-bonded hydrocarbon radicals, more preferably hydrocarbon radicals having 1 to 12 carbon atoms, especially methyl and phenyl and most preferably methyl.

Examples of X radicals are chlorine, bromine and iodine, the hydroxyl radical, alkoxy radicals, H₂N—, (CH₃)₂N—, CH₃NH—, (CH₃CH₂)₂N— and the CH₃CH₂NH— radical.

Preferably, radical X comprises radicals of the formula R⁷O—. Preferably, radical R⁷ comprises hydrogen or monovalent hydrocarbon radicals, more preferably hydrogen and hydrocarbon radicals having from 1 to 12 carbon atoms, especially hydrogen, methyl and ethyl.

Preferably, c is 3 or 0.

Silicone resins are generally well known and may comprise different siloxane units, such as so-called
M-units ≡SiO,
D-units ═SiO_{2/2}
T-units —SiO_{3/2} and
Q-units SiO_{4/2}.

A silicon network consisting almost exclusively of Q-units is very close to a pure SiO₂ crystal, i.e., the quartz crystal. The majority of silicone resins are synthesized from D- and T-units (DT resin) or, on the other hand, M- and Q-units (MQ resin), although other combinations such as MDT, MTQ or pure T resins are also produced industrially.

Component (C) used according to the present invention is more preferably an organopolysiloxane resin comprising units of formula (VI) where less than 25%, preferably less than 10% and more preferably less than 5% of the units in the resin have a c+d sum equal to 2.

More particularly, component (C) is an organopolysiloxane resin comprising units of formula (VI) which consist essentially of R⁶₃SiO_{1/2} (M) and SiO_{4/2} (Q) units where R⁶ is as defined above; in these MQ resins, the molar ratio of M- to Q-units is preferably in the range from 0.5 to 2.0 and more preferably in the range from 0.6 to 1.0. These silicone resins may also contain up to 10% by weight of free hydroxyl or alkoxy groups.

Preferably, the organopolysiloxane resins (C) used according to the present invention have a viscosity above 1000 mPas at 25° C. or are solids. The weight average molecular weight determined using gel permeation chromatography (on the basis of a polystyrene standard) for these resins is preferably in the range from 200 to 200,000 g/mol and especially in the range from 1000 to 10,000 g/mol.

The synthesis of organopolysiloxane resins (C) used according to the present invention is common general knowledge. They are usually prepared via hydrolytic condensation from various silane precursors, for which simple-to-obtain chlorosilanes were used for this in the beginning. Since process control proved very difficult with these starting materials, less reactive alkoxysilanes are mainly used these days. One specific form of silicone resins is that of MQ resins which are usually obtained from tetraethoxysilane (Q-unit) and trimethylethoxysilane (M-unit) via hydrolysis with hydrochloric acid. The chemical structure of silicone resins can be viewed as a three-dimensional network of polysilicic acid units terminated with trimethylsilyl groups. In addition, they can be a few ethoxy and hydroxyl functions. The average molecular weight can be accurately adjusted via the ratio of M- to Q-units.

Organopolysiloxane resins are preferably colorless, pulverulent solids which are very readily soluble in apolar solvents such as toluene but also in silicones.

When pulverulent silicone resins (C) are used, these can be used not only as solid material but also in solution. Examples of suitable solvents are liquid silicone resins comprising units of formula (VI), and silicone oils and liquid siloxanes of formulae (I) and (II).

In addition to the siloxanes (A), polyisocyanates (B) and organopolysiloxane resins (C), the preparations of the present invention may contain further substances, for example fillers (D), emulsifiers (E), physical blowing agents (F), catalysts (G), chemical blowing agents (H) and additives (I).

When fillers (D) are used, the fillers in question may be all nonreinforcing fillers, i.e., fillers having a BET surface area of up to 50 m²/g, such as chalk, or reinforcing fillers, i.e., fillers having a BET surface area of at least 50 m²/g, such as carbon black, precipitated silica or fumed silica. In particular both hydrophobic and hydrophilic fumed silicas represent a preferred filler. One particularly preferred embodiment of the invention uses a hydrophobic fumed silica whose surface has been modified with trimethylsilyl groups. The fillers (D) that are used—more particularly fumed silicas—may take on a variety of functions. Thus they may be used to adjust the viscosity of the foamable mixture. In particular, however, they are able to take on a “support function” in the course of foaming, and thus lead to foams having a better foam structure. Finally, the mechanical properties of the resultant foams may also be decisively improved through the use of fillers (D)—especially through the use of fumed silica. In addition, expandable graphite may also be added as filler (D).

When the preparations of the invention comprise fillers (D), the amounts in question are preferably 0.1 to 30 parts by weight, more preferably 0.1 to 20 parts by weight, and most preferably 0.1 to 15 parts by weight, all based on 100 parts by weight of siloxane (A). The preparations of the invention preferably do comprise fillers (D).

In many cases it is of advantage to add emulsifiers (E) to the foamable compositions. As suitable emulsifiers (E), which also serve as foam stabilizers, it is possible, for example, to use all commercial silicone oligomers that are modified with polyether side chains and that are also used in producing conventional polyurethane foams.

When emulsifiers (E) are used, the amounts in question are preferably up to 6% by weight, more preferably from 0.3% to 3% by weight, all based on the total weight of the foamable compositions. The preparations of the invention preferably contain no emulsifiers (E).

Moreover, the compositions may also comprise compounds (F) which are able to act as physical blowing agents. As constituent (F) it is preferred to use low molecular mass hydrocarbons such as, for example, propane, butane or cyclopentane, dimethyl ether, fluorinated hydrocarbons such as 1,1-difluoroethane or 1,1,1,2-tetrafluoroethane or CO₂. The formation of foam takes place preferably through a reaction of the polyisocyanate (B) with the chemical blowing agent component (H). The use of physical blowing agents (F) in combination with chemical blowing agent constituent (H) may be advantageous, in order to obtain foams having a relatively low density.

When the preparations of the invention comprise constituent (F), the amounts in question are from preferably 0.1 to 30 parts by weight, more preferably 0.1 to 20 parts by weight, and most preferably 0.1 to 15 parts by weight, all based on 100 parts by weight of siloxane (A). The preparations of the invention preferably contain no physical blowing agent (F).

The foamable preparations of the invention may further comprise catalysts (G) which accelerate the curing of the foam. Suitable catalysts (G) include organotin compounds. Examples are dibutyltin dilaurate, dioctyltin dilaurate, dibutyltin diacetate, dibutyltin dioctoate, dibutyltin bis(dodecylmercaptide) or tin(II) 2-ethylhexanoate. Moreover, tin-free catalysts (G) are contemplated as well, such as, for example, heavy-metal compounds or amines. Examples of tin-free catalysts include iron(III) acetylacetonate, zinc(II) octoate, zirconium(IV) acetylacetonate and bismuth(III) neodecanoate. Examples of amines are triethylamine, tributylamine, 1,4-diazabicyclo[2.2.2]octane, N,N-bis-(N,N-dimethyl-2-aminoethyl)methylamine, N,N-dimethyl-cyclohexylamine, N,N-dimethylphenylamine, bis-N,N-dimethylaminoethyl ether, N,N-dimethyl-2-aminoethanol, N,N-dimethylaminopyridine, N,N,N,N-tetramethyl-bis-2-aminoethylmethylamine, 1,5-diazabicyclo[4.3.0]non-5-ene, 1,8-diazabicyclo[5.4.0]undec-7-ene, N-ethyl-morpholine, tetramethylguanidine or N,N′-dimethyl-aminopyridine.

The catalysts (G) may be used individually or as a mixture. If desired, the catalysts used in the preparation of the siloxanes (A) may also serve simultaneously as catalysts (G) for foam curing.

When catalyst (G) is used, the amounts in question are preferably from 0.1% to 6.0% by weight, more preferably from 0.1% to 3.0% by weight, all based on the total weight of the foamable preparation of the invention. The compositions of the invention preferably do comprise catalysts (G).

As chemical blowing agents (H) it is possible in principle for not only water but also all compounds having preferably at least one isocyanate-reactive function to be used.

Examples of constituent (H) are aminoalkyl- or hydroxy-functional siloxanes other than component (A), monomeric alcohols, monomeric diols such as glycol, propanediol and butanediol, monomeric oligools such as pentaerythritol or trihydroxymethylethane, oligomeric or polymeric alcohols having one, two or more hydroxyl groups such as ethylene glycols or propylene glycols, water, monomeric amines having one, two or more amine functions such as ethylenediamine, hexamethylene-diamine, and also oligomeric or polymeric amines having one, two or more amine functions.

When constituent (H) is used, it preferably comprises hydroxy compounds, with water being particularly preferred.

When constituent (H) is used, the amounts are preferably 0.1 to 20 parts by weight, and most preferably from 0.1 to 15 parts by weight, more particularly from 0.1 to 10 parts by weight, all based on 100 parts by weight of siloxane (A). The compositions of the invention preferably do comprise constituent (H).

Examples of optional additives (I) are cell regulators, plasticizers, for example silicone oils which are different from component (A), flame retardants, for example melamine or phosphorus-containing compounds, especially phosphates and phosphonates, and also halogenated polyesters and polyols or chlorinated paraffins.

Examples of silicone oils (I) are triorganosiloxy-terminated polydiorgasiloxanes such as trimethylsiloxy-terminated polydimethylsiloxanes, and the siloxanes mentioned above under i).

The additives (I) preferably comprise cell regulators and flame retardants, of which flame retardants are particularly preferred.

When additives (I) are used, the amounts involved preferably range from 0.1 to 30 parts by weight, more preferably from 0.1 to 20 parts by weight and most preferably from 0.1 to 15 parts by weight, all based on 100 parts by weight of siloxane (A). The preparations of the present invention preferably contain no additives (I).

The components of the foamable preparation which are used according to the present invention may each comprise one type of such a component and also a mixture of two or more types of a particular component.

The preparations of the present invention preferably comprise those containing

(A) organosiloxanes,
(B) polyisocyanates,
(C) organopolysiloxane resins,
optionally
(D) fillers,
optionally
(E) emulsifiers,
optionally
(F) physical blowing agents,
optionally
(G) catalysts,
optionally
(H) chemical blowing agents, and optionally
(I) additives,
wherein the preparations according to the invention contain at least one blowing agent selected from components (F) and (H), more particularly at least (H).

Aside from components (A), (B) and (C) and also optionally one or more of components (D) to (I), the preparations of the present invention preferably do not contain any further constituents.

The preparations of the present invention are obtainable, then, in any desired conventional manner, such as simply mixing the individual components together, although pre-mixtures of individual constituents can also be prepared. It is preferable to prepare 2-part systems, wherein the two parts of the foamable preparation of the present invention contain all the constituents in any desired combinations and mixing ratios, with the proviso that one part does not simultaneously contain siloxanes (A) and polyisocyanates (B) and/or the constituents (B) and (H).

For instance, the preparation of the present invention is preferably obtained by preparing a mixture containing constituent (A) and (C), optionally constituent (D), optionally constituent (E), optionally constituent (F), optionally constituent (G), optionally constituent (H) and optionally constituent (I) as part and also a part 2 containing constituent (B) and these parts are then mixed together to obtain the foam of the present invention.

The preparations of the present invention are preferably liquid to highly viscous and have a viscosity of preferably 250 to 10,000 mPas and more preferably 500 to 5000 mPas, all measured at 25° C. as per ASTM D 4283.

The preparations of the present invention are preferably used in the manufacture of foams, more preferably rigid or flexible foams and most preferably flexible foams.

The present invention further provides a process for preparing a silicone-containing polyurethane foam, characterized in that a siloxane (A), a polyisocyanate (B), an organopolysiloxane resin (C) and at least one blowing agent are mixed and allowed to react.

In one preferred embodiment of the process according to the present invention, siloxane (A), polyisocyanate (B), organopolysiloxane resins (C), catalyst (G) and chemical blowing agent (H) and also optionally component (D) are mixed together and allowed to react directly thereafter.

In the process of the present invention, the foamable composition is preferably introduced into a mold which is subsequently closed such that the overpressure produced in foaming can escape. This can be realized for example by the mold having an overpressure valve or small openings, i.e., being incompletely closed via one or more narrow slots for example.

The molds used in the process of the present invention can be any kind of molds hitherto also used for producing molded foams. Examples of molds of this type are sealable and heatable metallic molds which are equipped with an overpressure valve to allow the displaced air to escape during the foaming process.

Preferably, the molds used according to the present invention are heatable molds composed of a solid material of construction, for example fiberglass-reinforced polyester or epoxy resins and also metals, such as steel or aluminum, in which case molds composed of steel and aluminum are preferably hydrophobicized with a priming paste, preferably once before use.

Examples of priming pastes with which the molds used in the process of the present invention can be hydro-phobicized are high-melting waxes based on hydrocarbons, for example as commercially available from Chem-Trend Deutschland GmbH, D-Maisach under the trade name of Kluberpur 55-0005.

If desired, the molds can be wetted with a release agent to ensure better demoldability of the foamed structures produced. Examples of such release agents are high-melting waxes dissolved in hydrocarbons, for example as available from Chem-Trend Deutschland GmbH, D-Maisach under the trade name of Kluberpur 41-0057. The process of the present invention preferably utilizes the molds used without release agent.

The molds used in the process of the present invention are preferably adjusted to temperatures of 0 to 150° C., more preferably 10 to 100° C. and especially 40 to 80° C.

In the process of the present invention, the expansion of the foam in the course of its formation is limited by the mold used, i.e., the mold is “overpacked”. This overpacking typically amounts to between 20% by volume and 100% by volume. Typical fill levels for a target foam density of 50 kg/m³ amount to about 5% by volume.

The heat formed in the course of the reaction according to the present invention preferably remains in the system and contributes to foam formation. The process of the present invention reaches reaction temperatures up to preferably from 50 to 150° C. in the foam core.

The process of the present invention is preferably carried out at the pressure of the ambient atmosphere, i.e., about 900 to 1100 hPa.

The process of the present invention preferably releases CO₂ which is very largely responsible for the building of the foam structure of the present invention.

In the process of the present invention, the demolding time, i.e., the time from filling the mold to removing the molded foam from the mold, is preferably in the range from 1 to 20 minutes, more preferably in the range from 2 to 15 minutes and especially in the range from 3 to 10 minutes.

The process of the present invention provides partially closed-cell foams which, by applying an external pressure, can be converted into completely open-cell foams, as for example by mechanically compressing the foamed structures as the foamed structure passes through two directly adjacent freely rotating rolls to compress the foamed structure to preferably above 75%.

The present invention further provides foams obtainable by reaction of siloxanes (A) with polyisocyanate (B), organopolysiloxane resin (C) and at least one blowing agent.

The foams of the present invention are notable for a fine, open-cell foam structure. Their mechanical properties are equivalent to those of commercially available PU foams.

The molded foams of the present invention preferably have a density of 10 to 500 kg/m³, more preferably 15 to 200 kg/m³ and most preferably 20 to 120 kg/m³, all determined at 25° C. and 1013 hPa.

The molded foams of the present invention have the advantage of having compact, defect-free and homogeneous outside surfaces.

The present compositions and also the present process for foam production have the advantage that no release agents are required.

The foamable preparations of the present invention have the advantage of being very simple to process using existing methods from PU technology.

The preparations of the present invention further have the advantage that they are obtainable using starting materials that are readily available commercially.

The preparations of the present invention further have the advantage that they are easy to process and are obtainable with low viscosity.

The preparations of the present invention have the advantage that silicone-polyurethane foams of low density are obtainable by the one-shot method.

The present invention process for producing silicone-containing PU foams has the advantage of being simple to carry out.

The foams of the present invention further have the advantage of being flexible and of extremely low flammability.

The foams of the present invention further have the advantage of having high mechanical strengths, particularly combined with low foam densities.

The foams of the present invention are usable wherever polyurethane foams have been used to date. More particularly, they are useful for upholstery.

In the examples below, all parts and percentage data, unless indicated otherwise, are by weight. Unless indicated otherwise, the examples below are carried out under the pressure of the ambient atmosphere, in other words at about 1000 hPa, and at room temperature, in other words about 20° C., or at a temperature which comes about when the reactants are combined at room temperature without additional heating or cooling. All of the viscosity data given in the examples are intended to be based on a temperature of 25° C.

In the examples, the following ingredients were used:

MDI: polymeric MDI having a functionality of 2.9 (commercially available from Huntsman Polyurethanes, Deggendorf, Germany, under the name Suprasec® 2085);
tolylene diisocyanate: mixture of 2,4- and 2,6-tolylene diisocyanate in a ratio of 80:20 (commercially available from Bayer MaterialScience AG, Leverkusen, Germany, under the name of Desmodur® T80);
amine catalyst: diazabicyclooctane (commercially available from Air Products GmbH, Hamburg, Germany, under the name DABCO® Crystal); silicone resin 1: pulverulent silicone resin consisting of M- and Q-units having an M/Q ratio of 2:3 (commercially available from Wacker Chemie AG, Burghausen, Germany, under the name of Belsil® TMS 803;
silicone resin 2: pulverulent silicone resin consisting of M- and Q-units having an M/Q ratio of 3:4, which includes 4% of vinyl groups (commercially available from Wacker Chemie AG, Burghausen, Germany under the name of Belsil® TMS 804.

The mold used in the examples which follow has dimensions of 40 cm×20 cm×5 cm and before use was hydrophobicized once with 25 g of priming paste bearing the designation “Klüberpur 55-0005” from Chem-Trend Deutschland GmbH, Maisach, Germany.

### Comparative Example 1

200.00 g of a linear organopolysiloxane of the formula HO—CH₂—[Si(CH₃)₂O]₂₉Si(CH₃)₂—CH₂—OH and 12.8 g of MDI were reacted in 400 ml of absolute acetone under an atmosphere of argon. The reaction was catalyzed with 60 mg of bismuth(III) neodecanoate and stirred at 50° C. After a reaction time of one hour, first 2.5 g of N-methylethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane and 5.1 g of water into a homogeneous mixture using a high-speed stirrer and then 54.4 g of tolylene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ was obtained with a distinctly visible inhomogeneous surface.

### Comparative Example 2

200.00 g of a linear organopolysiloxane of the formula HO—CH₂—[Si(CH₃)₂—O]₂₉Si(CH₃)₂—CH₂—OH and 12.1 g of MDI were reacted in 400 ml of absolute acetone under an atmosphere of argon. The reaction was catalyzed with 60 mg of bismuth(III) neodecanoate and stirred at 50° C. After a reaction time of one hour, first 3.0 g of diethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane and 5.1 g of water into a homogeneous mixture using a high-speed stirrer and then 56.7 g of tolylene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ was obtained. Compared with the foam of Comparative Example 1, a significantly more homogeneous surface was visible here, yet the foam surface still had an irregular texture.

### Inventive Example 1

200.0 g of a linear organopolysiloxane of the formula HO—CH₂—[Si (CH₃)₂O]₂₉Si(CH₃)₂—CH₂—OH and 12.1 g of MDI were reacted in 400 ml of absolute acetone under an atmosphere of argon. The reaction was catalyzed with 60 mg of bismuth(III) neodecanoate and stirred at 50° C. After a reaction time of one hour, first 3.0 g of diethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane, 5.1 g of water and additionally 3.0 g of silicone resin 1 into a homogeneous mixture using a high-speed stirrer and then 56.7 g of tolylene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ with a homogeneous and defect-free surface.

### Inventive Example 2

200.00 g of a linear organopolysiloxane of the formula HO—CH₂—[Si(CH₃)₂—O]₂₉Si(CH₃)₂—CH₂—OH and 12.1 g of MDI were reacted in 400 ml of absolute acetone under an atmosphere of argon. The reaction was catalyzed with 60 mg of bismuth(III) neodecanoate and stirred at 50° C. After a reaction time of one hour, first 3.0 g of diethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane, 5.1 g of water and additionally 5.0 g of silicone resin 1 into a homogeneous mixture using a high-speed stirrer and then 56.7 g of toluene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ with a homogeneous and defect-free surface.

### Inventive Example 3

200.00 g of a linear organopolysiloxane of the formula HO—CH₂—[Si(CH₃)₂—O]₂₉Si(CH₃)₂—CH₂—OH and 12.1 g of MDI were reacted in 400 ml of absolute acetone under an atmosphere of argon. The reaction was catalyzed with 60 mg of bismuth(III) neodecanoate and stirred at 50° C. After a reaction time of one hour, first 3.0 g of diethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane, 5.1 g of water and additionally 5.0 g of silicone resin 2 into a homogeneous mixture using a high-speed stirrer and then 56.7 g of toluene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ with a homogeneous and defect-free surface was obtained.

### Inventive Example 4

200.00 g of a linear organopolysiloxane of the formula HO—CH₂—[Si(CH₃)₂—O]₂₉Si(CH₃)₂—CH₂—OH and 12.1 g of MDI were reacted in 400 ml of absolute acetone under an atmosphere of argon. The reaction was catalyzed with 60 mg of bismuth(III) neodecanoate and stirred at 50° C. After a reaction time of one hour, first 3.0 g of diethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane, 6.0 g of water and additionally 3.0 g of silicone resin 1 into a homogeneous mixture using a high-speed stirrer and then 64.2 g of toluene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ with a homogeneous and defect-free surface was obtained.

### Inventive Example 5

200.00 g of a linear organopolysiloxane of the formula HO—CH₂—[Si (CH₃)₂—O]₂₄Si (CH₃)₂—CH₂—OH and 14.5 g of MDI were reacted in 400 ml of absolute acetone under an atmosphere of argon. The reaction was catalyzed with 60 mg of bismuth(III) neodecanoate and stirred at 50° C. After a reaction time of one hour, first 3.0 g of diethanolamine were gradually added dropwise and then the reaction mixture thus obtained was freed of solvent at a pressure of 10 hPa.

200.0 g of the hyperbranched organopolysiloxane thus obtained were initially emulsified with 500 mg of diazabicyclooctane, 5.2 g of water and additionally 3.0 g of silicone resin 1 into a homogeneous mixture using a high-speed stirrer and then 60.0 g of toluene diisocyanate were added to this emulsion and incorporated with a high-speed stirrer for 10 s. Of the mixture thus obtained, 200 g were immediately introduced into a 4 L aluminum mold temperature controlled to 70° C. and the mold was closed for a period of 10 min except for a 100 μm wide and 40 cm long slot to allow the displaced air to escape. After a demolding time of 10 min, a silicone-PU foam having a density of 50 kg/m³ with a homogeneous and defect-free surface was obtained.

1.-10. (canceled)

11. A foamable composition comprising:
A) a siloxane (A) of the formula
V—(NHC(O)R¹R²)ₚ₋ₘ₋ₙ(NHC(O)R¹R⁴[SiR₂O]ₐ—SiR₂R⁴R¹H)ₘ(NHC(O)NR⁵₂)ₙ (I)
where
V is a p-valent hydrocarbon radical optionally containing heteroatoms,
R each individually is a monovalent, optionally substituted hydrocarbon radical,
R¹ each individually is —O—, —S— or —NR³—,
R² each individually is hydrogen or a monovalent, optionally substituted hydrocarbon radicals,
R³ each individually is hydrogen or a monovalent, optionally substituted hydrocarbon radical,
R⁴ each individually is a divalent, optionally substituted hydrocarbon radical optionally interrupted by heteroatoms,
R⁵ each individually is hydrogen or an optionally substituted hydrocarbon radical,
a is an integer not less than 1,
p is an integer not less than 2,
m is an integer not less than 1,
n is an integer not less than 1;
with the proviso that p is not less than m+n,
B) a polyisocyanate (B); and
C) an organopolysiloxane resin (C).

12. The foamable composition of claim 11, wherein p is equal to m+n.

13. The foamable composition of claim 11, wherein component (B) has the formula
Q(NCO)_{b} (V)
where
Q is a b-functional, optionally substituted hydrocarbon radical, and
b is an integer of at least 2.

14. The foamable composition of claim 11, wherein the organo-polysiloxane resin (C) comprises units of the formula
R⁶_{c}X_{d}SiO_{(4-c-d)/2} (VI)
where
R⁶ each individually is hydrogen or a monovalent, optionally substituted, SiC-bonded hydrocarbon radical,
X each individually is halogen, a radical R⁷O— or a radical R⁷₂N—, wherein R⁷ each individually is hydrogen or a monovalent, optionally substituted hydrocarbon radical,
c is 0, 1, 2 or 3, and
d is 0, 1, 2 or 3,
with the proviso that the sum total c+d is ≦3 and in less than 50% of all units of formula (VI) in the organopolysiloxane resin the sum c+d is equal to 2.

15. The foamable composition of claim 11, comprising
(A) organosiloxanes,
(B) polyisocyanates,
(C) organopolysiloxane resins,
(D) optionally, fillers,
(E) optionally, emulsifiers,
(F) optionally, physical blowing agents,
(G) optionally, catalysts,
(H) optionally, chemical blowing agents, and
(I) optionally, additives,
wherein the foamable composition contains at least one blowing agent component (F) and/or (H).

16. The foamable composition of claim 15, wherein blowing agent (H) is present.

17. A process for preparing a silicone-containing polyurethane foam, comprising mixing a siloxane (A), a polyisocyanate (B), an organopolysiloxane resin (C) and at least one blowing agent, and reacting the mixture to form a foam.

18. The process of claim 17, wherein the foamable composition is introduced into a mold prior to forming the foam.

19. The process of claim 17, wherein the foamable composition is introduced into a mold in a manner such that the expanding foam can displace the ambient air from an incompletely closed mold.

20. The process of claim 17, wherein the mold is overpacked.

21. A foam obtained by reaction of a foamable composition of claim 11.
